(19) United States
(12) Patent Application Publication
(10) Pub. No.: US 2003/0063949 A1
(43) Pub. Date: Apr. 3, 2003

(54) Expandable key for interconnecting a shaft and hub

(76) Inventor: Gert Dieter Hohenocker, Karlsruhe (DE)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 10/302,094

(22) Filed: Nov. 22, 2002

Related U.S. Application Data
(63) Continuation of application No. PCT/DE01/01894, filed on May 18, 2001.

(30) Foreign Application Priority Data
May 23, 2000 (DE) 100 25 405.5

(51) Int. Cl. B25G 3/20; F16B 7/04

(52) U.S. Cl. 403/367

(57) ABSTRACT

An expandable key for being received in registering channels which form a keyway in a hub member and a shaft member. The key includes an expansion member composed of a plurality of parallel fillets which collectively have a rectangular cross sectional peripheral outline and a bore extending longitudinally therebetween, and at least one clamp body positioned within the bore. A threaded tensioning member extends through the bore of the fillets and threadedly engages a bore in the clamp body, such that upon rotation of the tensioning member the clamp body is drawn into the bore to expand the fillets. The clamp body and the bore of the fillets have interengaging generally flat tapered surfaces which are in the form of a truncated four sided pyramid.

### BACKGROUND OF THE INVENTION

The present invention relates to an expandable key for positive and non-positive interconnection of a shaft and hub, and which comprises a clamp body, an expandable member having a bore which receives the clamp body, and a tensioning member, whereby the key may be tightened in a keyway formed by registering axial channels in the shaft and hub.

The key can be readily inserted in the keyway (as standardized e.g. in DIN 6885) and can be easily assembled and disassembled.

Known are positive, non-positive (with friction contact), and both positive and non-positive (position with friction contact) shaft-hub connections. An example of a merely positive connection is the conventional standardized parallel key (DIN 6885 and others). This kind of connection is in widespread use but is not suitable to alternating loads. Especially if it has been manufactured unprecisely or subjected to alternating loads, experience shows that it will either work loose, or become hard to disassemble due to rust or corrosion.

Non-positive (friction) connections are achieved e.g. by shrink fit, a tapered key or grip springs. Because of the high radial forces required to achieve friction contact, the hub must be very thick-walled. In addition, they are difficult to assemble and hard to disassemble.

An example for a suitable both positive and friction connection is the connection by means of double taper keys in a tangential direction. The torque is hereby transferred as pressure force in the circumferential direction by pretensioned tapered faces. Machining the grooves in shaft and hub, however, is expensive, and assembly as well as disassembly are difficult.

U.S. Pat. No. 3,378,285 discloses a key which can be inserted into a keyway and, by tensioning a screw, can be expanded diagonally towards the corners of the keyway. The clamp body (bodies) provided there are shaped conically, so that line contact and edge pressure occur when tensioning the part, so that this device is not suited to transmit high and alternating torques. Furthermore, disassembly of this device is not believed to be possible without its destruction.

The present invention therefore is based upon the task of creating a shaft-hub connection which can be mounted in shafts and hubs with conventional channels, especially keyways, but is also suitable to alternating loads and can be easily assembled and disassembled.

### SUMMARY OF THE INVENTION

The above and other objects and advantages of the invention are achieved by the provision of an expandable key which includes an expansion member composed of a plurality of fillets which collectively have a rectangular cross sectional peripheral outline and a central bore extending therebetween. At least one clamp body is positioned within the bore, and a tensioning member extends through the bore and engages the clamp body and acts to draw the clamp body into the bore and expand the fillets.

The bore of the expansion member is defined at least in part by generally flat inwardly facing tapered surfaces on respective ones of the fillets and which collectively are in the form of a truncated pyramid. Also, the outer periphery of the clamp body is defined by a plurality of tapered generally flat expansion surfaces which conform to the taper of and engage respective ones of the tapered surfaces of the bore of the expansion member. Thus a generally planar contact is achieved between the clamp body and the bore of the fillets, and between the exterior of the fillets and the keyway.

According to the invention, it has been recognized that a shaft-hub connection for alternating loads, i.e. alternating torques, can be realized by a key which is shaped so that there is mainly at least, plane contact between the appropriately arranged surfaces so that they can transmit the torque as pressure forces. The key can, by tightening the tensioning member, be brought to positive contact with the keyway so that, in an especially advantageous manner, no high demands are made as to the precision of the keyway which may be slightly deformed, whereby still, by tightening the tensioning member, mainly at least, plane contact can be achieved between the clamp body, the fillets, and the keyway.

In an especially preferred embodiment, the key can be expanded in both radial and tangential directions with respect to the keyway. Thus, plane contact can be achieved, mainly at least, between an outer surface of the key and the corresponding faces, i.e. bottom and sides, of the keyway. Insofar, the key will accommodate even to a less precise or slightly deformed keyway, while still a high torque can be transmitted. The key could also be expanded in a diagonal direction with respect to the keyway, towards the corners of the keyway. This will mainly be the case when the cross section of the keyway is square and not rectangular.

The key is mainly meant to fit a keyway, preferably according to DIN 6885. Furthermore, designing of the key according to this invention generally for a keyway of any dimensions or shapes can be imagined.

As noted above, it is provided that there is, mainly at least, plane contact between the clamping body and each fillet. Preferably, the dimensions of the corresponding contact faces are, at least approximately, equal so that the component is symmetrical with respect to force transmission.

The clamp body can, at least when the component is inserted in the keyway, be tensioned against the fillets by the tensioning member. Especially, a counterpiece can be provided which can be tensioned by the tensioning member against the clamping body and/or the fillets.

The engaging surfaces of the clamp body and/or the fillets are preferably tapered or shaped as truncated pyramids. As the fillets are, at least mainly, complementary to the clamp body, the fillets also show corresponding shapes. The counterpiece could also be tapered or shaped as a truncated pyramid, but also it could be shaped as a parallelepiped or a washer.

The counterpiece has a through bore through which the tensioning member can extend.

The clamp body could comprise a stud bolt onto which a nut can be threaded. Stud and nut would here serve as the tensioning member to pull the clamp body with the stud towards the nut and thus tensioning the clamp body against the fillets which in turn are pressed against the keyway. Furthermore, there could be a counterpiece with a through bore mounted on the stud so that, by tensioning the nut, the clamp body would be drawn towards the counterpiece and thus the clamp body could be tensioned against the fillets as well as the counterpiece against the fillets.

In an alternative design, the tensioning member may take the form of a screw (or bolt). The clamp body has a threaded bore complementary to the screw. Now the counterpiece with the through bore can be mounted on the screw and the latter be screwed into the internal thread of the clamp body. By tensioning the screw, the clamp body would likewise be drawn towards the counterpiece and thus likewise the fillets be tensioned against the clamp body and against the keyway.

Preferably, the number of fillets should correspond to the number of corners of the keyway. Thus for a keyway of rectangular section, four fillets should be provided. Also, the outer shape of the assembled key preferably corresponds to the keyway.

For ease of assembly, the fillets are held together by an elastic element placed preferably at a central location along the length of the key. The elastic element could for example consist of a rubber ring, a shrink tube, or an adhesive tape. Likewise for ease of assembly, the fillets could be glued to the clamp body and also to the counterpiece, with the glued joint cracking open when tensioning the key. Furthermore, the contact faces of the clamp body, the fillets and, if applicable, the counterpiece could be shaped so that there is no self-locking on assembly, for example by arranging the taper of the faces under a certain angle.

For ease of disassembly, an internal thread can be provided in the through bore of the counterpiece, which is larger than the internal thread of the clamp body. So, if in disassembly, the component should not become loose by itself, the clamp body could first be loosened by a blow onto the partly loosened screw. To loosen the counterpiece, a larger screw could be threaded into the larger thread of the counterpiece so that the clamp body would be pushed apart from the counterpiece.

Positive shaft-hub connections, like the widely used parallel key, tend to work loose when subjected to alternating loads, whereas non-positive shaft-hub connections require thick-walled hubs and are difficult to assemble and hard to disassemble. The new key is intended to be mounted into standard keyways, provide a both positive and non-positive connection and be assembled and disassembled easily.

In one specific embodiment, the key, which will also be referred to as an expandable key, consists of four fillets provided with two sets of tapered surfaces forming oppositely oriented truncated four sided pyramids, and two clamp bodies shaped as mating truncated pyramids, specifically one clamp body and one counterpiece. The bodies are tensioned by means of a screw and thus press the fillets into the corners of the keyway, so that the torque is transmitted over the inclined surfaces as pressure force.

The key can be applied wherever parallel or tapered keys have hitherto been used, especially under varying loads in case of repair, as there are no high demands to the precision of the keyway. At the same time, the hub is fixed axially to the shaft.

There are several ways to construct and develop the teaching of the present invention. Thereto reference is made to the following explanation of the preferred embodiments of the invention by means of the drawing. Together with the explanation, preferred embodiments and developments of the teaching in general will be explained.

### BRIEF DESCRIPTION OF THE DRAWINGS

In the drawings:

FIG. 1 is a schematic representation of a first embodiment of the present invention in an exploded view;

FIG. 2 is a schematic representation of the first embodiment of the present invention in an assembled condition;

FIG. 3 is a schematic representation of another embodiment of the present invention in an exploded view;

FIG. 4 is a schematic representation of the embodiment of FIG. 3 in an assembled condition, and

FIG. 5 is a schematic representation of a shaft-hub connection by means of a key according to the present invention.

### DETAILED DESCRIPTION OF THE PREFERRED EMBODIMENTS

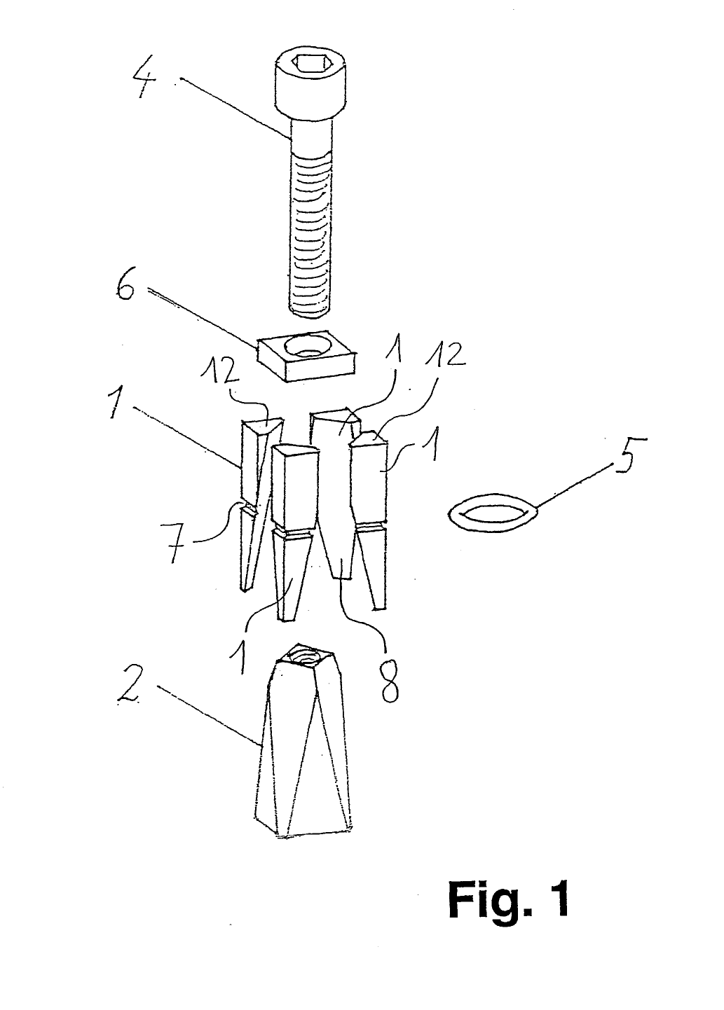

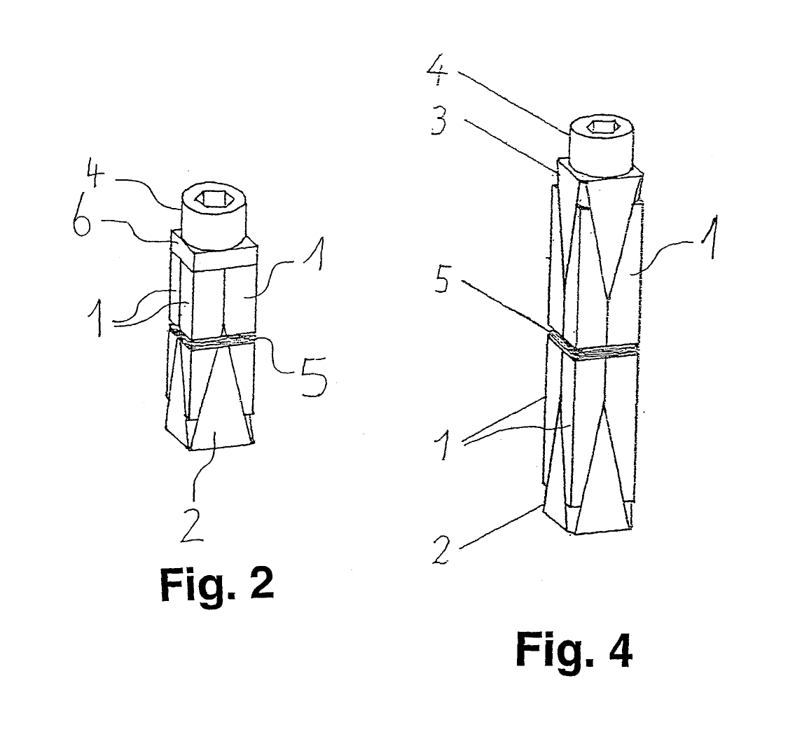

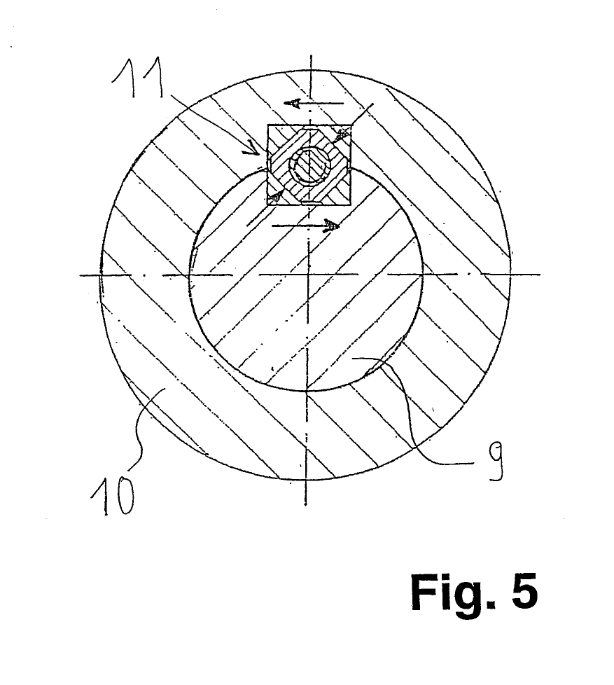

FIGS. 1 and 2 show a first embodiment of an expandable key according to the present invention, and which includes an expansion member which is composed of four fillets 1 of mainly square or rectangular cross section. The fillets 1 are dimensioned so that they together can with some clearance be inserted into a standard keyway 11, which is shown schematically in FIG. 5. For ease of assembly, the fillets 1 are held together by a rubber ring 5 inserted into a groove 7.

The assembled fillets collectively have a rectangular cross sectional peripheral outline as best seen in FIG. 5, and they define a central bore which extends between the fillets in a longitudinal or axial direction. The bore is defined by generally flat inwardly facing tapered surfaces 8 on respective ones of the fillets and which collectively are in the form of a truncated four sided pyramid. The surfaces 8 are designed so that no self locking will occur in use as described below.

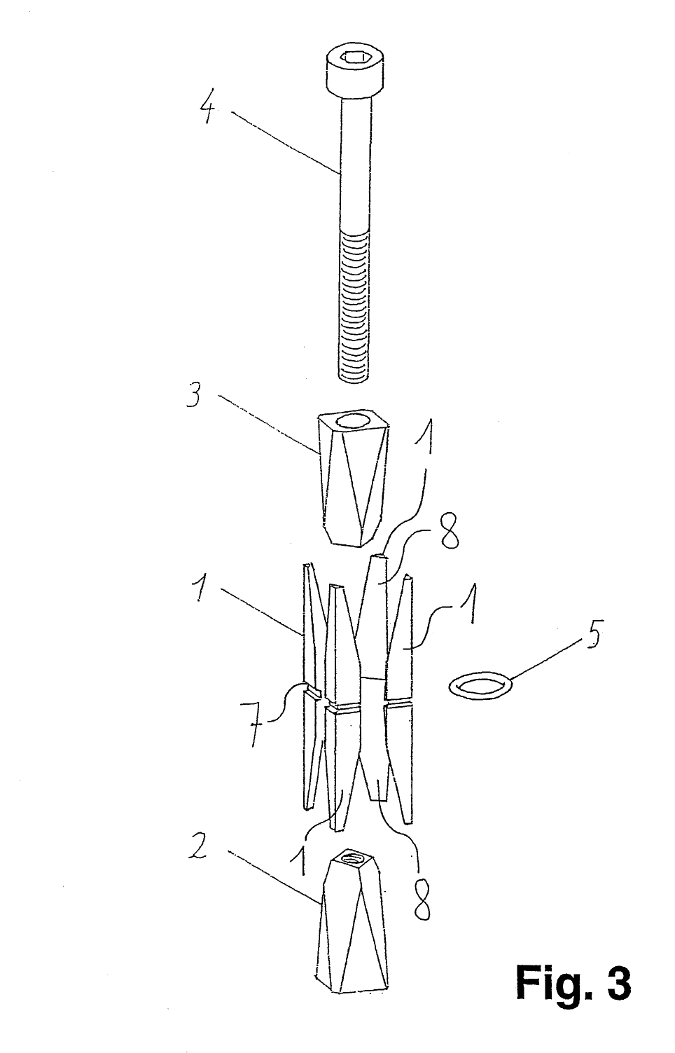

In the embodiment of FIGS. 3 and 4, the fillets 1 each have two inclined surfaces 8 which form opposite end portions of the bore of the expansion member.

The inclined surfaces 8 of a fillet 1 in FIG. 1 is in contact with a clamp body 2 shaped essentially as a truncated pyramid. The clamp body is drawn against a counterpiece 6 shaped as a washer by a screw 4 which acts as a tensioning device, so that the fillets 1 can be expanded and pressed diagonally into the corners of the keyway. The two inclined surfaces of each fillet in FIG. 3 are in contact with a clamp body 2 shaped essentially as a truncated pyramid and a counterpiece 3 likewise shaped as a truncated pyramid. By tensioning the screw 4 acting as a tensioning device, shown here as an Allen screw, the pyramid shaped clamp body 2 is drawn toward the likewise pyramid shaped counterpiece 3, so that the fillets 1 can be expanded and pressed diagonally into the corners of the keyway. Thus, the expandable key shown in FIG. 3 is tensioned symmetrically, i.e. the fillets 1 are expanded from both ends.

FIG. 5 shows schematically the shaft 9, upon which the hub 10 has been coaxially mounted. A keyway 11 is formed by registered axially extending channels in the hub and shaft, and the keyway has a rectangular or essentially square outline in cross section. A key according to the invention of FIG. 4 is shown inserted in the keyway. The torque is now transferred from the keyway in the shaft to the keyway in the hub by means of the inclined surfaces 8 of the fillets 1, the clamp body 2 and the counterpiece 3

For assembly, it is only required that the keyway in the shaft and hub be accessible from the end of the shaft, such as by a groove of smaller cross section, leaving room only for the spanner matching the screw 4. The expandable key is tensioned by tightening the screw 4, as opposed to connections by grip springs where several screws have to be tensioned repeatedly in circular or crosswise sequence.

Disassembly is accomplished by loosening the screw 4. If the clamp body and counterpiece should not come loose by themselves, the clamp body 2 can be loosened by a blow on the screw 4. Alternatively, or additionally, the counterpiece 3 could contain a larger thread in its bore, and, by inserting a matching screw, clamp body 2 could be pushed away from counterpiece 3; or clamp body 2 and counterpiece 3 could be pushed apart by a bushing firmly connected to screw 4 (not shown in FIGS. 1 and 3).

The expandable key can also be inserted into keyways which are machined with lower accuracy or, in case of repair, are already damaged. A further advantage is that the collar 10 is fixed frictionally to the shaft 9 in the axial direction by tensioning the expandable key, without shifting during assembly. Additional axial locking devices, such as set screws, circlips or retaining nuts, are not required.

FIG. 1 through 4 show a key for positive and non-positive shaft-hub connection. The key comprises a clamp body 2, an expansion member formed by the fillets 1 which conform to the clamp body, and a tensioning member 4. The key can be expanded into registered axial channels which form a keyway 11.

According to the invention, the clamp body 2 and the fillets 1 are shaped so that there is, at least essentially, plane contact between the clamp body 2, the fillets 1 and the keyway.

The keys according to the invention as shown in FIGS. 1 through 4 differ in the shapes of the counterpiece and fillets. In FIG. 1, the counterpiece is shaped as a washer 6 with a through bore which can be tensioned against the flat upper ends 12 of the fillets 1. In FIG. 3, an embodiment is shown where the counterpiece 3 as well as the clamp body 2 are shaped as truncated pyramids. Correspondingly, the fillets 1 each have two sets of inclined surfaces 8 establishing plane contact with the clamp body 2 as well as the counterpiece 3.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

1. An expandable key for being received in registered axial channels which form a keyway in a hub member and a shaft member, said key comprising
an expansion member comprising a plurality generally parallel fillets which collectively have a rectangular cross sectional peripheral outline and a central bore extending therebetween, with said bore being defined at least in part by generally flat inwardly facing tapered surfaces on respective ones of the fillets and which collectively are in the form of a truncated pyramid,
at least one clamp body positioned within the bore of the expansion member and having an outer periphery defined by a plurality of tapered generally flat expansion surfaces which conform to the taper of and engage respective ones of the tapered surfaces of the bore of the expansion member, and
whereby the clamp body can be drawn into the bore of the expansion member to expand the fillets radially outwardly, and whereby there is generally planar contact between the surfaces of the clamp body and the surfaces of the bore of the expansion member.

2. The key as defined in claim 1 further comprising a tensioning member extending into the bore of the fillets for engaging and drawing the clamp body into the bore of the expansion member.

3. The key as defined in claim 2 wherein the tensioning member threadedly engages a bore in the clamp body so that rotation of the tensioning member causes the clamp body to advance into the bore of the expansion member and radially expand the fillets.

4. The key as defined in claim 3 wherein the clamp body is positioned within one end portion of the bore of the fillets, and further comprising a counterpiece having a bore through which the tensioning member extends and wherein the counterpiece is positioned to abut the ends of the fillets which are opposite the end portion which receives the clamp body.

5. The key as defined in claim 4 wherein the fillets are separate from each other, and further comprising a band surrounding the fillets at a medial location along their length to releasably hold the fillets together.

6. The key as defined in claim 5 wherein the band is an endless elastic member.

7. The key as defined in claim 3 wherein the clamp member is glued to the fillets along the engaging tapered surfaces.

8. The key as defined in claim 4, wherein the bore of the counterpiece is threaded with a thread of larger diameter then that of the tensioning member.

9. The key as defined in claim 1 wherein the expansion member consists of four fillets which have a generally square cross sectional peripheral outline with the fillets located at respective corners of the square cross sectional outline.

10. The key as defined in claim 9 wherein the engaging surfaces of the clamp body and the expansion member are configured such that the fillets expand relative to the keyway in both the radial and tangential directions.

11. An expandable key for being received in registered axial channels which form a keyway in a hub member and a shaft member, said key comprising
an expansion member consisting of four generally parallel fillets which collectively have a generally square cross sectional peripheral outline and a central bore extending therebetween, with said bore including opposite end portions, with each end portion being defined by generally flat inwardly facing tapered surfaces on respective ones of the fillets and which collectively are in the form of a truncated four sided pyramid, and with the truncated pyramids of the opposite end portions being oppositely oriented,
a clamp body positioned within one end portion of the bore and having a periphery defined by four tapered generally flat expansion surfaces which conform to the taper of and engage respective ones of the tapered surfaces of the one end portion of the bore,
a counterpiece positioned within the other end portion of the bore and having a periphery defined by four tapered generally flat expansion surfaces which conform to the taper of and engage respective ones of the tapered surfaces of the other end portion of the bore. and
a tensioning member extending freely through a bore in said counterpiece and threadedly engaging a threaded bore in said clamp body,
whereby upon rotation of the tensioning bolt the clamp body and the counterpiece can be drawn toward each other to expand the fillets radially outwardly, and
whereby there is generally planar contact between the surfaces of the clamp body and the surfaces of the bore at the one end portion, and between the surfaces of the counterpiece and the surfaces of the bore at the other end portion.

12. The key as defined in claim 11 wherein the fillets are located at respective corners of the square cross sectional outline of the fillets.
